(19) United States
(12) Patent Application Publication
(10) Pub. No.: US 2010/0257019 A1
(43) Pub. Date: Oct. 7, 2010

(54) ASSOCIATING USER-DEFINED DESCRIPTIONS WITH OBJECTS

(75) Inventors: David Maxwell Chickering, Bellevue, WA (US); Edith Lok Man Law, Pittsburgh, PA (US); Anton Mityagin, Woodinville, WA (US); Gonzalo Alberto Ramos, Bellevue, WA (US); Aparna Lakshmiratan, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/416,939

(22) Filed: Apr. 2, 2009

(51) Int. Cl. G06Q 10/00; G06F 17/30; G06F 17/00

(52) U.S. Cl. 705/10; 463/44; 463/9; 707/E17.014; 707/E17.045

(57) ABSTRACT

Interactively associating user-defined descriptions with objects. At least two users create descriptions based on provided objects. The users analyze the descriptions to determine whether the users were provided with the same or different objects. If all the users are correct in their determinations, associations between the created descriptions and the corresponding objects are adjusted. In some embodiments, the users interact via a two-player game where the input is obfuscated and the output is optionally obfuscated. For example, the users each provide a search query responsive to receipt of a search intention. If a single search intention was provided and all the users make the correct determination, the search queries are associated with the search intention.

### BACKGROUND

Existing systems such as search engines provide information based on descriptions received from a user. The search engines infer intent based on the received descriptions, and provide the information based on the inferred intent. For example, if the user types “weather redmond wa” as a search query, the search engines infer that the user is interested in a forecast for the city of Redmond, Wash. The search engines might obtain and provide a five-day forecast within the search results along with the other links.

Existing systems, however, fail to consistently and accurately infer the intent of search queries at least because of the numerous search queries that may correspond to the same intent. For example, the search queries “Redmond forecast”, “is it going to rain tomorrow in Redmond”, and the like may all correspond to the same intent to obtain a forecast for Redmond. While query logs provide some insight into intent, the hundreds or thousands of search queries in the query logs in existing systems have to be manually labeled to extract meaningful data from them.

### SUMMARY

Embodiments of the invention identify descriptions for association with objects. A plurality of the objects is defined. Each of the objects is obfuscated. One or more of the obfuscated objects are provided to a plurality of users. Each of the users receives one of the obfuscated objects. The users each create the descriptions based on the provided objects. Each of the users reviews the descriptions from the other users. Each of the users makes a determination as to whether the users were provided the same objects. Associations between the descriptions and the provided objects are adjusted based on the determinations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating users interacting with a computing device storing a mapping between objects and descriptions.

FIG. 2 is an exemplary flow chart illustrating operation of the computing device to associate descriptions with objects based on determinations from the users.

FIG. 3 is an exemplary block diagram illustrating players interacting with the computing device to play a game to map search queries to search intentions.

FIG. 4 is an exemplary flow chart illustrating operation of the game to map search queries to search intentions.

FIG. 5 is an exemplary user interface for the game in which the players compare search results to determine if both players received the same search intention.

FIG. 6 is an exemplary user interface illustrating various instant answers corresponding to search intentions.

Corresponding reference characters indicate corresponding parts throughout the drawings.

### DETAILED DESCRIPTION

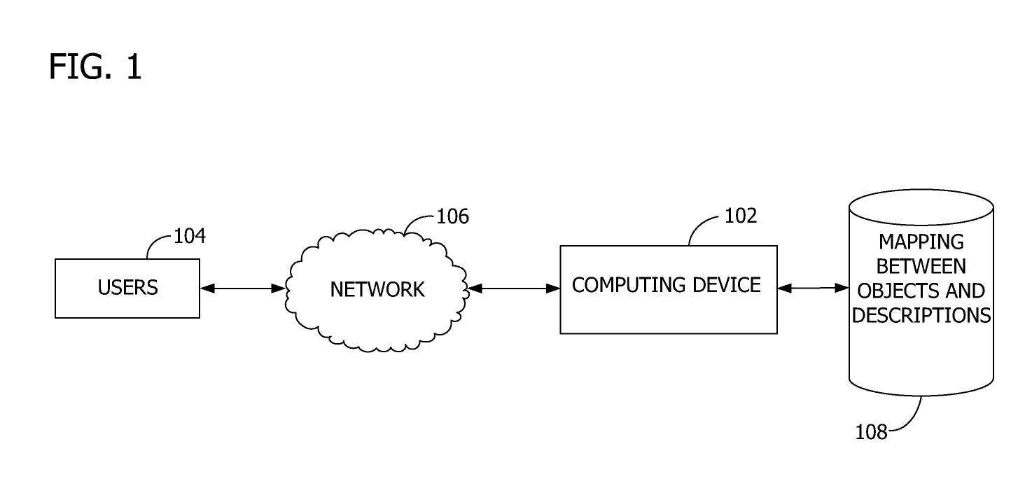

Referring to the figures, embodiments of the disclosure enable, at least, the collection of object-to-description mappings 108. For example, a set of intent-to-query mappings may be collected in a search engine embodiment. Such a mapping enables the intent behind a particular search query to be inferred. As shown in FIG. 1, an exemplary block diagram illustrates users 104 interacting with a computing device 102 storing the mapping 108 between descriptions and objects. The users 104 interact with the computing device 102 via a network 106 such as, for example, the Internet.

The data gathered by aspects of the disclosure may be used to learn a grammar or a set of linguistic patterns of how people express intentions in search queries 312. For example, while “what is the weather like in Seattle” and “weather forecast in Seattle” are search queries 312 for finding out about the weather in Seattle, these same linguistic patterns may be used to detect the intention of seeking information about the weather of any other cities. Knowing the intent of a search query allows for more intelligent and targeted ways of retrieving relevant search results (e.g., with fewer query reformulations) thereby enhancing the user experience by providing a complete set of results limited to the intent of the search query.

While embodiments of the disclosure describe the descriptions and objects with reference to search queries 312 and search intent, aspects of the disclosure are not limited to a search embodiment. Rather, other examples include: (1) human-generated written or voice descriptions of driving directions from one address to another to inform an automated system that provided directions, and (2) human-generated written or voice descriptions of images to inform an image-search system that used such descriptions as input.

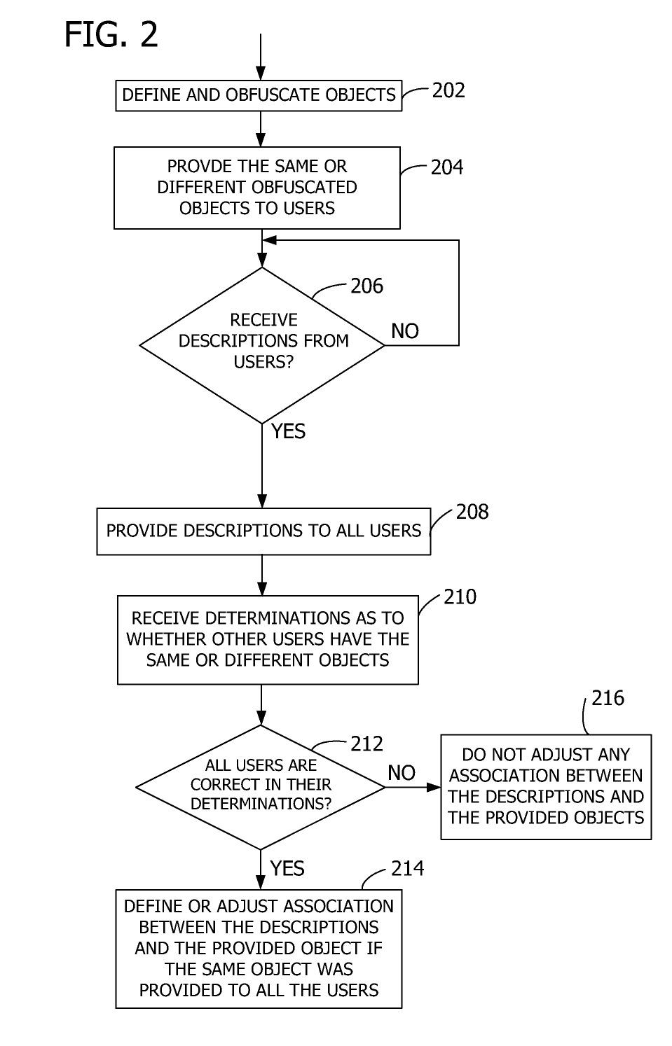

Referring next to FIG. 2, an exemplary flow chart illustrates operation of the computing device 102 to associate descriptions with objects based on determinations from the users 104. At 202, a plurality of the objects is defined. Each of the objects is obfuscated. The objects include representations or manifestations of articles, concepts, or the like. For example, the objects may represent search intentions 310 (e.g., the information desired to be obtained via a web or database search) or include text, images, and/or video. At 204, the same or different obfuscated objects are provided to the users 104. For example, the same object may be provided to each of the users 104, or different objects may be provided. The users 104 each receive one of the objects. The users 104 create or compose descriptions of the received object. If the descriptions are received from the users 104 at 206, the descriptions are provided to the other users 104 for review at 208. Each of the users 104 can review the descriptions created by the other users 104 and determine or guess whether the other users 104 have been provided the same or different objects. The determination by the user 104 represents a belief by the user 104 as to whether each of the other users 104 has been provided the same object based on the review of the descriptions created by those users 104.

The determinations are received at 210. If all the determinations are correct at 212, associations between the created descriptions and the provided object are defined or adjusted at 214. In a two-user example, if the same object was provided to both users 104 and both users 104 guessed this correctly, the created descriptions are associated with the object. If the created descriptions are already associated with the object, the ranking or weighting of the created descriptions is adjusted to indicate a greater association between the descriptions and the object. Conversely, if different objects were provided to both users 104 and both users 104 guessed this correctly, any association between the first object and the description for the second object, or between the second object and the description for the first object, is adjusted to indicate less of an association.

If not all the determinations are correct at 212, no adjustment is made at 216.

In some embodiments, the determinations from the users 104 include a value representing a quantity of the objects believed by each user 104 to have been provided. For example, in a two-player game, each user 104 makes a guess as to whether one or two objects (e.g., the same or different objects, respectively) have been provided. In such embodiments, the operations performed at 212 include determining the actual quantity of the provided objects and comparing the determined quantity to the value provided by each user 104.

Alternatively, the determinations from the users 104 include a different form of indication as to whether each user 104 has received the same or different objects. For example, each user 104 may type in the text “same” or “different” or select such a button or checkbox in a user interface. In such embodiments, the operations performed at 212 include comparing the text or selection from each user 104 with the correct determination.

In some embodiments, the operations performed at 214 include ranking the associated descriptions for the provided object. The ranking occurs based on various factors including, for example, a reputation of the user 104 creating the descriptions. In such an example, the descriptions from users 104 with higher reputations are ranked higher or weighted more than descriptions from users 104 with lower reputations.

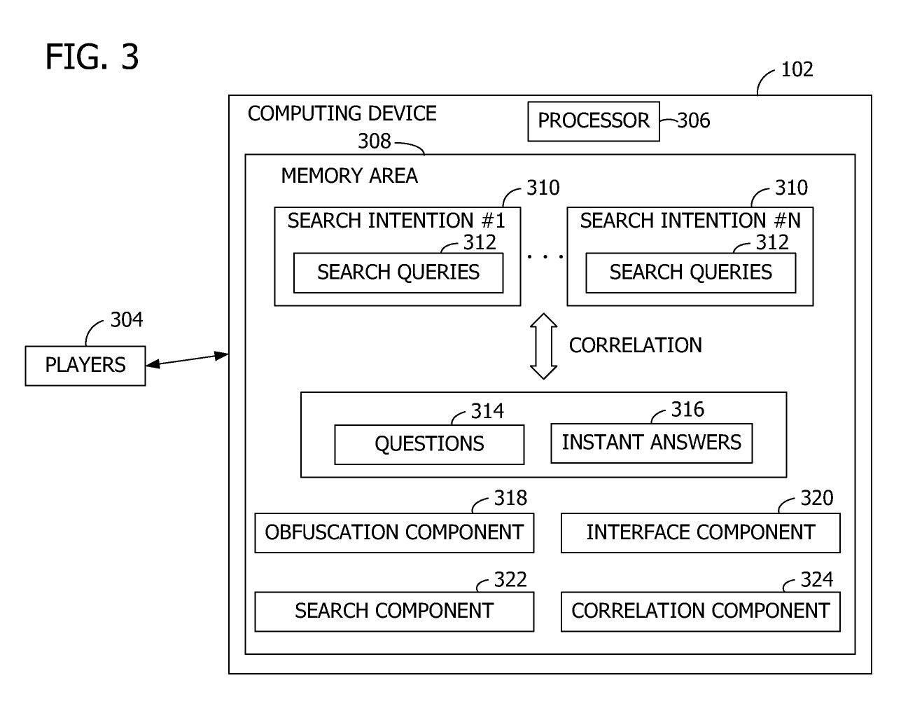

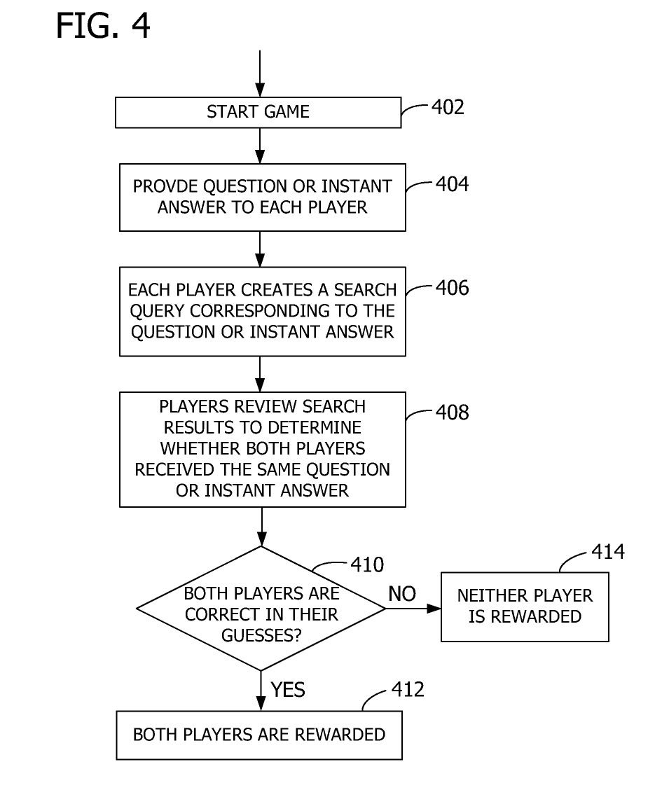

Referring next to FIG. 3, an exemplary block diagram illustrates players 304 interacting with the computing device 102 to play a game to map search queries 312 to search intentions 310. The game rewards the players 304 based on an analysis by the players 304 of search results. The computing device 102 includes a memory area 308 and a processor 306. The memory area 308, or other computer-readable media, stores a plurality of search intentions 310 such as search intention #1 through search intention #N. Each of the search intentions 310 has one or more search queries 312 associated therewith. Aspects of the disclosure, as described for example with reference to FIG. 4, identify and associate the search queries 312 with the search intentions 310.

The memory area 308 further stores a correlation between each of the search intentions 310 and one or more questions 314 and/or one or more instant answers 316. For example, if the search intention 310 is to identify the weather in Redmond, Wash., the correlated question 314 may be “What is the weather in Redmond, Wash.?” For the same search intention 310, the instant answer 316 may be “Redmond has light rain and 40 degrees.” In general, the instant answer 316 represents a concise result for some informational desire, and may include images, text, or other data.

In general, the memory area 308 is associated with the computing device 102. For example, in FIG. 3, the memory area 308 is within the computing device 102. However, the memory area 308 or any of the data stored thereon may be associated with any server or other computer, local or remote from the computing device 102 (e.g., accessible via a network).

The processor 306 is programmed to execute computer-executable instructions for implementing aspects of the disclosure. As an example, the processor 306 is programmed to execute instructions such as those illustrated in the figures (e.g., FIG. 2 and FIG. 4).

The memory area 308 further stores one or more computer-executable components. The components include an obfuscation component 318, an interface component 320, a search component 322, and a correlation component 324. The obfuscation component 318 generates a plurality of the questions 314 related to one or more of the search intentions 310.

In some embodiments, the obfuscation component 318 operates as follows. A set of predefined topics is selected (e.g., sports, medical procedures, companies, movies, celebrities, drug-condition interactions, products, etc.). For each topic, a set of question templates is created. Each question template is associated with a topic identifier and a question identifier. Questions 314 with the same topic identifier are similarly parameterized. For example, questions 314 about a particular drug (e.g., “what are the effects of Drug A?” and “what is the cost of Drug A?”) and questions 314 about the appropriateness of a drug for a particular condition (e.g., “can Drug A be taken during pregnancy?” and “can Drug A be taken by people with a heart condition?”) have two distinct topic identifiers. Questions 314 with the same topic and question identifiers are paraphrases of each other (e.g., “what is the cost of Drug A?” and “how much does Drug A cost?”) and are considered to be representations of the same search intention 310.

To construct questions 314 for the same search intention 310, questions 314 with the same topic and question identifier are randomly sampled. To construct questions 314 that are different but easily distinguishable, questions 314 may be sampled where the subjects are vastly different (e.g., drug versus movie, or female celebrity versus company) as shown by their different topic identifiers. Alternatively, questions 314 with the same topic and question identifiers, but with different entities substituted, may also be sampled.

To generate questions 314 that are different but more difficult to discriminate, questions 314 may be selected where the subjects are the same, but that the information inquired about the subjects is different. These are questions 314 with the same topic identifier but different question identifiers, and the same entity substituted. For example, the following are two question templates: “How much do the tickets cost for <game>?” and “Who won the <game>?”. For these templates, the tag <game>may be substituted with a specific game name. In this example, the players 304 are each given an intention to find some information about the specific game name. However, the particular kind of information sought (e.g., ticket price versus game result) differs. For the players 304 to tell that the questions 314 given to them are different, the players 304 judge from the search results that the questions 314 are about different aspects of the same subject.

In some embodiments, a mix of easy and difficult pairs of search intentions 310 is served in the game. The mix may be determined dynamically by observing the quantity of mistakes players 304 have made so far, and selecting the pairs of questions 314 accordingly to maintain a high level of player enjoyment.

The interface component 320 provides one or more of the questions 314 to the users 104. Each of the users 104 receives one of the questions 314. Each of the users 104 composes a search query 312 corresponding to the received question 314.

The search component 322 receives the search query 312 from each of the users 104. In some embodiments, the search component 322 performs a search on data using the received search queries 312 to generate search results. The search component 322 then provides the search results to the users 104. In other embodiments, another component (not shown) not associated with the computing device 102 performs the search and provides the search results to the users 104. In any embodiment, the users 104 are able to view the search results produced from their own search query 312 as well as the search results from the search queries 312 produced by the other user(s).

Each of the users 104 analyzes the search results and makes a determination. The determination indicates whether the user 104 believes that each of the users 104 has been provided with the questions 314 corresponding to the same search intention 310. The interface component 320 receives the determination from each of the users 104. Based on the determinations received by the interface component 320, the correlation component 324 adjusts an association between the search queries 312 and the search intentions 310. In some embodiments, the correlation component 324 defines an association between the search queries 312 and the search intention 310 if the determinations received from the users 104 are correct and if the provided questions 314 correspond to the same search intention 310. For example, the correlation component 324 compares the determinations to the known quantity of the search intentions 310 for which questions 314 were provided by the interface component 320. In embodiments, the correlation component 324 ranks or weights the search queries 312 such as described above with reference to FIG. 2.

Referring next to FIG. 4, an exemplary flow chart illustrates operation of the game to map search queries 312 to search intentions 310. The game starts at 402. For example, the game may take the form of a web service, an application or applet downloaded from a web site, a mobile telephone application, or any other form. At 404, one or more questions 314 are provided to a plurality of players 304. For example, the questions 314 may be the same or different. As shown in FIG. 3, the questions 314 correlate to search intentions 310. In some embodiments, rather than questions 314, answers 316 are provided.

Each of the players 304 receives one of the questions 314. Each of the players 304 creates a search query 312 at 406 corresponding to the provided question 314. Based on the search queries 312, search results are obtained and provided to the players 304. For example, each of the players 304 receives the search results corresponding to their search query 312, as well as the search results corresponding to the search queries 312 from the other player(s). The players 304 review the search results at 408 to determine whether the players 304 received the same question 314.

In the two-player example, if both players 304 are correct in their determinations at 410, both players 304 are rewarded at 412. For example, if both players 304 correctly determine that the same question 314 was provided to both players 304, or that different questions 314 were provided to each player 304, both players 304 are rewarded. The reward may include any form of congratulations, accolades, or even compensation or credit. If, in the two-player example, either of the players 304 is incorrect in their determinations at 410, neither player 304 is rewarded at 414.

The exemplary operations illustrated in FIG. 2 and FIG. 4 may be performed by one or more processors executing within the computing device 102, or performed by a processor external to the computing device 102 (e.g., in a cloud service).

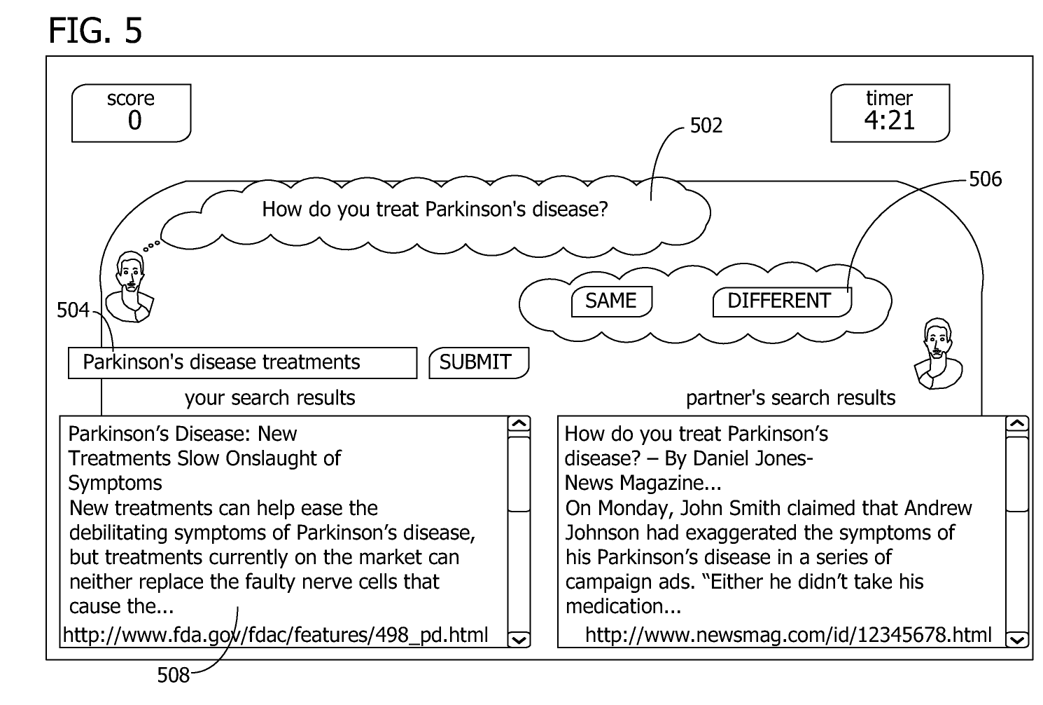

In the two-player example, an example user interface for the game is next described with reference to FIG. 5.

Referring next to FIG. 5, an exemplary user interface for the game illustrates the players 304 comparing search results to determine if both players 304 received the same search intention 310. The game randomly matches the player 304 with another player 304. The user interface of FIG. 5 illustrates the view by one of the players 304. At 502, the player 304 is given search intention 310 in the form of a question such as question 314 or an instant answer such as instant answer 316, which is either the same or different from the one given to another player 304. At 504, the player 304 types in a search query 312 that may retrieve an answer for the question 314. The search query 312 is sent to a search engine, which retrieves a set of search results that are displayed to both the player 304 and to the other player 304 at 508. After seeing the partner's search results, both of the players 304 decide whether they were given the same intention 310. The players 304 select one of the two buttons “same” or “different” at 506. If both of the players 304 are correct in their guesses, both of the players 304 are rewarded.

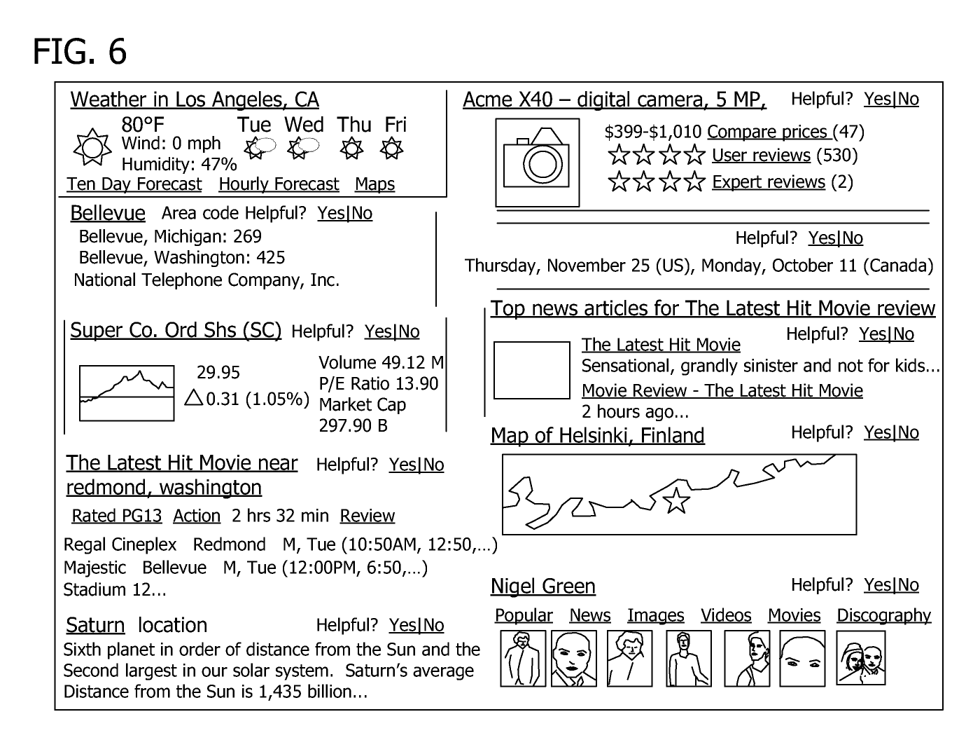

Referring next to FIG. 6, an exemplary user interface illustrates various instant answers 316 corresponding to search intentions 310. In an alternative embodiment to FIG. 5, the objects provided to the players 304 are obfuscated as instant answers 316. FIG. 6 illustrates various instant answers 316 that may be provided, including weather information for a city, the area code for a city, stock quotes, movie show times, facts about planets, product information, dates for major holidays, news snippets, maps, and celebrity profiles.

### Exemplary Operating Environment

By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles (including handheld gaming consoles), portable music players, a personal digital assistant, an information appliance, a personal communicator, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for identifying a plurality of the search queries 312 that correspond to the same search intention 310, and exemplary means for obfuscating the search intentions 310.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for rewarding players of a game based on an analysis of search results, said system comprising:
a memory area for storing a plurality of questions, said memory area further storing a correlation between each of a plurality of search intentions and one or more of the questions; and
a processor programmed to:
provide one or more of the questions from the memory area to a plurality of players, wherein each of the plurality of players receives one of the questions, and wherein said one or more of the questions correlate to one or more of the plurality of search intentions;
receive a search query from each of the plurality of players, said received search query being created by the players and corresponding to the provided questions;
obtain search results associated with performance of each of the received search queries;
provide the obtained search results associated with the search queries to each of the players, wherein the players analyze the search results;
receive a determination from each of the players, said determination indicating whether the player believes that each of the plurality of players was provided the same question; and
reward the players based on the received determinations.

2. The system of claim 1, wherein the processor is further programmed to provide the received search queries to a search engine to generate the search results.

3. The system of claim 1, wherein the processor is programmed to reward the players by rewarding the players if the determinations from each of the players are correct.

4. The system of claim 1, wherein the processor is further programmed to determine a quantity of the provided questions and compare the determined quantity to the received determinations to assess whether the determinations from each of the players are correct.

5. The system of claim 1, further comprising means for identifying the received search queries that correspond to the same search intention.

6. The system of claim 1, further comprising means for obfuscating the search intentions.

7. A method comprising:
defining and obfuscating a plurality of objects;
providing one or more of the obfuscated objects to a plurality of users, wherein each of the plurality of users receives one of the obfuscated objects;
receiving a description from each of the plurality of users, said received description being created by the users and corresponding to the provided objects, providing the received descriptions to each of the plurality of users;
receiving a determination from each of the users indicating whether the user believes that each of the plurality of users was provided the same object, said determination being based on the provided descriptions; and
associating the received descriptions with the provided objects based on the received determinations.

8. The method of claim 7, wherein providing the defined objects comprises providing one or more representations of search intentions.

9. The method of claim 8, wherein receiving the description comprises receiving a search query from each of the plurality of users, said received search query being created by the users and corresponding to the provided representations of the search intentions, wherein providing the received descriptions to each of the plurality of users comprises providing search results associated with performance of each of the received search queries to each of the plurality of users, and wherein the users analyze the search results.

10. The method of claim 8, wherein providing the representations of the search intentions comprises providing one or more questions corresponding to the search intentions.

11. The method of claim 8, wherein providing the representations of the search intentions comprises providing one or more images corresponding to the search intentions.

12. The method of claim 7, wherein associating the received descriptions comprises adjusting an association between the received descriptions and the provided objects.

13. The method of claim 7, wherein associating the received descriptions comprises associating the received descriptions with the provided objects if each of the determinations is correct and the same obfuscated object was provided to each of the users.

14. The method of claim 7, further comprising ranking the descriptions based on a reputation of the user associated therewith.

15. The method of claim 7, wherein the provided objects comprise one or more of the following: text, images, and video.

16. The method of claim 7, further comprising weighting the association between the descriptions and the provided objects.

17. One or more computer-readable media having computer-executable components, said components comprising:
an obfuscation component for generating a plurality of questions related to search intentions;
an interface component for providing one or more of the generated questions to a plurality of users, wherein each of the plurality of users receives one of the questions;
a search component for receiving a search query from each of the plurality of users, said received search query being created by the users and corresponding to the provided questions, wherein the users obtain search results associated with performance of each of the received search queries, and wherein the users analyze the obtained search results;
wherein the interface component receives a determination from each of the users indicating whether the user believes that each of the plurality of users was provided the same question; and
a correlation component for adjusting an association between each of the search queries and the corresponding search intentions based on the determinations received by the interface component.

18. The computer-readable media of claim 17, wherein the correlation component adjusts an association between the search queries and the search intention if the determinations received from each of the plurality of users are correct and the questions provided to the users correspond to the same intention.

19. The computer-readable media of claim 17, wherein the correlation component adjusts the association by weighting the search queries.

20. The computer-readable media of claim 17, wherein the interface component provides the questions in a game.
